(19) United States
(12) Patent Application Publication
(10) Pub. No.: US 2024/0035697 A1
(43) Pub. Date: Feb. 1, 2024

(54) AIR QUALITY CONTROL SYSTEM WITH MOBILE SENSORS

(71) Applicant: Johnson Controls Tyco IP Holdings LLP, Milwaukee, WI (US)

(72) Inventors: Jonathan D. Douglas, Mequon, WI (US); Kirk H. Drees, Cedarburg, WI (US)

(73) Assignee: Johnson Controls Tyco IP Holdings LLP, Milwaukee, WI (US)

(21) Appl. No.: 18/266,164

(22) PCT Filed: Dec. 8, 2021
(86) PCT No.: PCT/US2021/062444

§ 371 Date: Jun. 8, 2023

Related U.S. Application Data
(60) Provisional application No. 63/123,184, filed on Dec. 9, 2020.

(51) Int. Cl. F24F 11/52; F24F 11/30

(52) U.S. Cl. CPC F24F 11/52; F24F 11/30; F24F 2110/64

(57) ABSTRACT

A mobile sensor for a building includes a sensor, and a wireless transceiver. The sensor is configured to measure an indoor air quality parameter in an air sample at a current location of the mobile sensor as the mobile sensor transports through the building. The wireless transceiver is configured to transmit the measurement of the indoor air quality parameter and an indication of the current location of the mobile sensor to a building controller.

### CROSS-REFERENCE TO RELATED PATENT APPLICATIONS

This application claims the benefit of and priority to U.S. Provisional Patent Application No. 63/123,184, filed Dec. 9, 2020, the entire disclosure of which is incorporated by reference herein.

### BACKGROUND

The present disclosure relates to HVAC systems. More particularly, the present disclosure relates to determining air quality of a space that an HVAC system serves.

### SUMMARY

One implementation of the present disclosure is a building environmental control system, according to some embodiments. In some embodiments, the environmental control system includes a mobile sensing unit and a building controller. In some embodiments, the mobile sensing unit includes an air sampling system and a sensor. In some embodiments, the sensor is configured to measure an air parameter in an air sample at a current location of the mobile sensing unit. In some embodiments, the building controller is configured to obtain a measurement of the air parameter, and an indication of the current location from the mobile sensing unit. In some embodiments, the building controller is configured to operate building equipment based on the measurement of the air parameter and the indication of the current location to affect an environmental condition of the building or to reduce an infection risk in the building.

In some embodiments, the building environmental control system further includes a fleet of the mobile sensing unit. In some embodiments, the fleet of mobile sensing units are configured to transport throughout the building and provide the building controller with a plurality of measurements of the air parameter at locations throughout the building. In some embodiments, the mobile sensing units are configured to provide the building controller with corresponding indications of locations of the measurements of the air parameter.

In some embodiments, the mobile sensing unit includes a wireless transceiver configured to transmit the measurement of the air parameter at the current location, and the indication of the current location to the building controller. In some embodiments, the sensor is configured to detect a DNA or RNA sequence of a virus in the air sample at the current location of the mobile sensing unit.

In some embodiments, the mobile sensing unit further includes a security camera configured to obtain image data as the mobile sensing unit transports through the building. In some embodiments, the mobile sensing unit is configured to transmit the image data to the building controller.

In some embodiments, the air parameter includes at least one of an indoor air quality or an infectious quanta. In some embodiments, the air sampling system is a vacuum system for cleaning a floor of a building as the mobile sensing unit transports through the building and the sensor is provided on a modular unit and is retrofit on the mobile sensing unit. In some embodiments, the mobile sensing unit includes at least one of an aural alert device or a visual alert device configured to activate to provide an alert to an occupant at the current location in response to the sensor detecting a virus in the air at the current location.

Another implementation of the present disclosure is a mobile sensor for a building, according to some embodiments. In some embodiments, the mobile sensor includes a sensor, and a wireless transceiver. In some embodiments, the sensor is configured to measure an indoor air quality parameter in an air sample at a current location of the mobile sensor as the mobile sensor transports through the building. In some embodiments, the wireless transceiver is configured to transmit the measurement of the indoor air quality parameter and an indication of the current location of the mobile sensor to a building controller.

In some embodiments, the mobile sensor is configured to transport along a predetermined route through the building. In some embodiments, the sensor is configured to detect a DNA or RNA sequence of a virus in the air sample at the current location of the mobile sensor.

In some embodiments, the mobile sensor further includes a security camera configured to obtain image data as the mobile sensor transports through the building. In some embodiments, the mobile sensor is configured to transmit the image data to the building controller.

In some embodiments, the building controller is configured to use the image data to detect a number of occupants of the building at locations in the building. In some embodiments, the sensor and the wireless transceiver are provided on a modular unit and are retrofit on the mobile sensor. In some embodiments, the mobile sensor includes at least one of an aural alert device or a visual alert device configured to activate to provide an alert to an occupant at the current location in response to the sensor detecting a measurement of the indoor air quality parameter that exceeds a threshold at the current location.

Another implementation of the present disclosure is a method for controlling an indoor air quality in a building, according to some embodiments. In some embodiments, the method includes obtaining samples from air in the building at a plurality of different locations of the building using at least one autonomous cleaning device configured to transport through the building, perform a cleaning operation, and collect air samples. In some embodiments, the method includes measuring an air parameter in the building using the air samples. In some embodiments, the method includes operating building equipment based on the air parameter to affect an indoor air quality in the building.

In some embodiments, the step of measuring the air parameter is performed locally on-board the autonomous cleaning device. In some embodiments, the step of measuring the air parameter is performed off-board the autonomous cleaning device. In some embodiments, the autonomous cleaning device is configured to collect and deliver the samples to a dock location in the building for measuring the air parameter.

In some embodiments, the method further includes operating an aural alert device or a visual alert device of the autonomous cleaning device to notify an occupant regarding the air parameter in the building. In some embodiments, the air parameter is at least one of an infectious particle in the air, or an indoor air quality.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a diagram of an indoor air quality (IAQ) control system including one or more autonomous devices that include sensors, according to some embodiments;

FIG. 2 is a diagram of one of the autonomous devices of FIG. 1, according to some embodiments; and

FIG. 3 is a block diagram of a control system for the IAQ system of FIG. 1 using inputs from one or more of the autonomous devices, according to some embodiments.

FIG. 4 is a flow diagram of a process for controlling a building system, according to some embodiments.

FIG. 5 is a block diagram of a biological sampling system, according to some embodiments.

### DETAILED DESCRIPTION

Before turning to the FIGURES, which illustrate the exemplary embodiments in detail, it should be understood that the present application is not limited to the details or methodology set forth in the description or illustrated in the FIGURES. It should also be understood that the terminology is for the purpose of description only and should not be regarded as limiting.

### Overview

Referring generally to the FIGURES, a system can include mobile devices, such as autonomous vacuum cleaning devices that include one or more sensors (e.g., air quality sensors, DNA/RNA sensors, etc.), according to some embodiments. The autonomous vacuum cleaning devices may be configured to travel about a building zone or a room and track their location throughout the room, according to some embodiments. The autonomous vacuum cleaning devices can provide sensor data and corresponding position to a controller, which can be used to adjust operation of one or more building devices or systems. Advantageously, the autonomous vacuum cleaning devices can function as mobile sensors, thereby reducing or removing a need to install sensors throughout the room. In some implementations, the mobile sensors may supplement fixed sensors and/or other mobile sensors in the space to provide more accurate/granular information to the system.

### System Overview

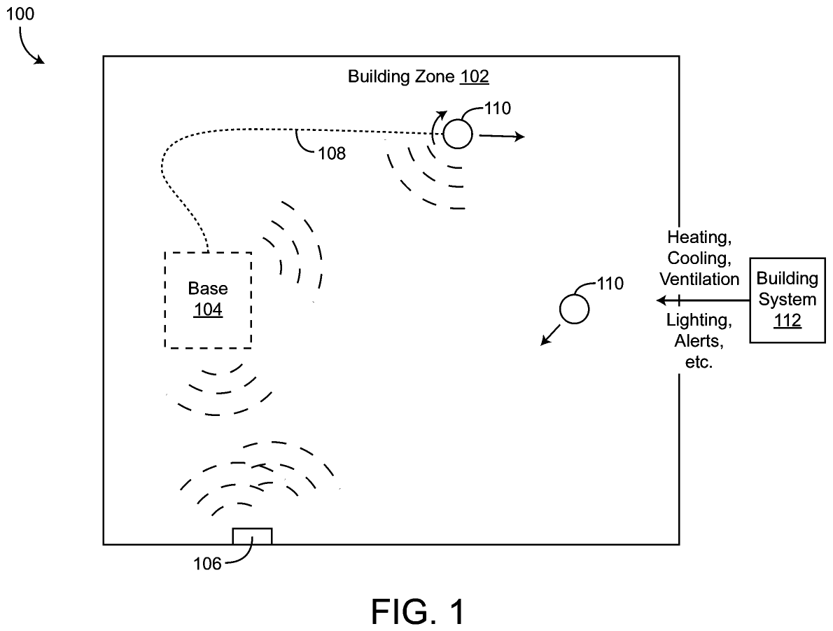

Referring particularly to FIG. 1, a system 100 for a building zone 102 is shown, according to some embodiments. The building zone 102 is a room, a space, an area, etc., of a building, a house, a factory, a manufacturing facility, an office space, etc., according to some embodiments. For example, the system 100 may be implemented in a residential setting, a manufacturing setting, an office setting, etc., according to some embodiments. The building zone 102 is shown as a single space, but may include any number of rooms, zones, sub-rooms, sections of a room, a floor of a building, an aggregation of multiple zones, etc., according to some embodiments.

In some embodiments, the system 100 includes a base 104, a controller 106, and one or more mobile devices, such as autonomous devices 110 (e.g., autonomous robots, mobile devices, drones, autonomous vacuum cleaners, etc., or any other autonomously movable, translatable, flyable, or repositionable devices that are configured to autonomously move about the building zone 102), that are designed to move around within the building zone 102. It should be understood that, while the one or more autonomous devices 110 are described herein as autonomous vacuum cleaning robots, this is for illustrative purposes, and should not be understood as limiting. For example, the one or more autonomous devices 110 may include a combination of autonomous vacuum cleaning robots, drones, individuals with smartphones having one or more sensors, etc., according to some embodiments. Further, in some implementations, non-autonomous devices may be used instead of or in addition to autonomous devices 110. For example, in some implementations, a mobile device such as a ground or air-based device (e.g., car or other wheeled device, drone, etc.) may be moved around the space manually by a user, either via remote control (e.g., radio frequency, WiFi, Bluetooth, etc.) or by manually moving the device around the space (e.g., walking a wheeled or handheld device around the space). While the disclosure below generally discussed autonomous devices, it should be understood that implementations with non-autonomous devices are contemplated by and fall within the scope of the present disclosure.

In some embodiments, the one or more autonomous devices 110 are configured to move about the building zone 102 (e.g., along a path 108) to perform various operations at different locations about the building zone 102 (e.g., vacuum cleaning operations, sanitization operations, service operations, etc.). The one or more autonomous devices 110 can include a primary mover (e.g., an electric motor) that is configured to drive the autonomous device 110 to move about the building zone 102 (e.g., by driving wheels, driving a tread, driving a tractive element, etc.), according to some embodiments. In some embodiments, the one or more autonomous devices 110 can include one or more additional primary movers or electric motors for performing the various operations (e.g., an electric motor configured to drive a vacuum cleaning apparatus, etc.). In some embodiments, the one or more autonomous devices 110 also include an energy storage device (e.g., a battery, a plurality of battery cells, etc.). In some embodiments, the one or more autonomous devices 110 are configured to use energy stored in the energy storage device to power the primary movers for mobility and/or performing different operations throughout the building zone 102.

The base 104 may be or include a zone, a charging station, a controller, a processor, etc., according to some embodiments. In some embodiments, the one or more autonomous devices 110 are configured to return to the base 104 (e.g., for charging). The one or more autonomous devices 110 may capture data (e.g., sensor data, position data, route data, etc.) as the autonomous devices 110 travel along their route, and may provide any of the collected data to the base 104 when the autonomous devices 110 return to the base 104. In some embodiments, the one or more autonomous devices 110 are configured to communicate with the base 104 when the autonomous devices 110 return to the base. In some embodiments, the autonomous devices 110 are configured to communicate wirelessly with the base 104 and/or the controller 106 as the autonomous devices 110 travel about the building zone 102. The autonomous devices 110 can be configured to communicate with the base 104 and/or the controller 106 using a wireless communications protocol (e.g., Bluetooth, LoRa, Zigbee, WiFi, cellular communications, radio transmission, etc.). In some embodiments, the autonomous devices 110 are configured to connect with a wireless network of a building of the building zone 102 and transmit information (e.g., position data, sensor data, operational data, etc.) to the base 104 and/or the controller 106 as the autonomous devices 110 travel about the building zone 102. In this way, information or data from the autonomous devices 110 can be provided to the base 104 and/or the controller 106 in real-time or near real-time. In some embodiments, the autonomous device 110 is configured to log and track information obtained along its route (e.g., position data and corresponding sensor data, operational data, etc.) and provide the logged information to the base 104 when the autonomous devices 110 return to the base 104. In this way, information from the autonomous devices 110 can be obtained intermittently when the autonomous devices 110 return to the base 104 (e.g., for charging).

In some embodiments, the controller 106 and the base 104 are configured to communicate wirelessly using any of the wireless communications protocols described herein. In this way, any information provided to the base 104 by the autonomous devices 110 can also be provided to the controller 106 (e.g., intermittently and/or in real-time as described in greater detail above).

In some embodiments, the system 100 includes a building system 112. The building system 112 may be a heating, ventilation, or air conditioning (HVAC) system. In some embodiments, the controller 106 is configured to operate the building system 112 to provide heating, cooling, and/or ventilation to the building zone 102. In some embodiments, the HVAC system is a variable refrigerant flow (VRF) system, a single stage HVAC system, a multi-stage HVAC system, a variable air volume (VAV) HVAC system, etc., or any other system or combination of systems configured to provide heating, cooling, and/or ventilation to the building zone 102. The HVAC system can include building equipment (e.g., a chiller, a VRF device, a fan, etc.) configured to operate to affect an environmental or variable condition of the building zone 102. The building system 112 may also be or include a lighting system, an alert system, a fire suppression system, a reporting system, an optimization system, etc., according to some embodiments.

In some embodiments, the one or more autonomous devices 110 include an environmental condition sensor, an IAQ sensor, etc., or an array of one or more sensors. The autonomous devices 110 can obtain, collect, measure, detect, etc., different values of different environmental conditions, such as IAQ, particulate matter, smoke presence, a fire condition, etc., as the autonomous devices 110 travel about the building zone 102. In some embodiments, the autonomous devices 110 are configured to provide sensor data and position to the controller 106 and/or the base 104 in real-time, near real-time or in an intermittent basis (e.g., when the autonomous devices 110 return to the base 104).

In some embodiments, the one or more autonomous devices 110 include sensors configured to measure a comfort condition of the building zone 102, an IAQ of the building zone 102, a biological parameter of the building zone 102, and/or a safety parameter of the building zone 102. More generally, the sensors (e.g., the sensors 220) can be configured to measure an air parameter which may be or include an indoor air quality parameter, a presence or concentration of a particular type of biological matter or quanta, a specific detection of a DNA or RNA sequence, etc. In some embodiments, for example, the one or more autonomous devices 110 include any of or a combination a temperature sensor, a humidity sensor, and/or a sensor configured to measure mean radiant temperature. In some embodiments, the one or more autonomous devices 110 include any of or a combination of a carbon dioxide (CO2) sensor, a PM 2.5 sensor, a PM 10 sensor, a sensor configured to measure volatile organic compounds (VOC), a sensor configured to measure ozone, a sensor configured to measure ion concentration, and/or a sensor configured to measure light intensity or ultraviolet (UV) light. In some embodiments, the one or more autonomous devices 110 include a carbon monoxide sensor, a flammable gas sensor (e.g., a sensor configured to measure natural gas), a smoke detector (e.g., a sensor configured to measure soot, smoke, etc.), and/or a sensor configured to measure a presence or concentration of industrial chemicals (e.g., gaseous, liquid, particulate matter, etc.). In some embodiments, the one or more autonomous devices 110 include a sensor that is configured to measure, detect, sense, or otherwise sample air for a specific ribonucleic acid (RNA and/or DNA) (e.g., COVID-19). For example, in such embodiments, the one or more autonomous devices 110 may include a sensor that detects for DNA/RNA associated with a particular disease or pathogen to detect presence of the disease/pathogen. In various embodiments, any combination of the sensors discussed herein could be incorporated into the one or more autonomous devices 110 and used in combination or in isolation to detect conditions in the building zone 102.

Temperature in the building zone 102 may vary based on a wide variety of parameters, according to some embodiments. Obtaining a temperature mapping of the building zone 102 can facilitate achieving uniform comfort throughout the building zone 102, according to some embodiments. Mean radiant temperature is a component in human thermal comfort, according to some embodiments. Mean radiant temperature is a measure of how warm or cold surrounding walls of a space are. Obtaining mean radian temperature also facilitates achieving uniform comfort throughout the building zone 102, according to some embodiments. CO2 is a measure of an amount of ventilation that is provided per occupant of the building zone 102. High levels of CO2 may indicate insufficient ventilation. The CO2 of building zone 102 may vary spatially due to differences in HVAC airflow distribution, according to some embodiments. The PM 2.5 and PM 10 sensors are sensors that are configured to measure an amount of particles in the air of the building zone 102. The PM 2.5 sensor is configured to measure 2.5 micrometer particles, which may be more harmful to occupants if inhaled. The PM 10 sensor is configured to measure an amount of 10 micrometer particles that are in the air of the building zone 102 and may be more indicative of dust or dirt in the building zone 102. VOC is a measure of volatile organic compounds in the building zone 102. In some embodiments, VOCs may be found in paints, cleaners, or other chemicals. A concentration of VOCs may vary throughout the building zone 102 due to variation in usage of paints, cleaners, chemicals, etc. Ozone is a byproduct of high voltage electric discharge and may be detected near electronic devices. In some embodiments, air disinfection devices may generate ions for disinfecting the air. Measuring the ionic concentration in the building zone 102 can facilitate ensuring that uniform ionic concentration is achieved throughout the building zone 102. Carbon monoxide, industrial chemicals, or flammable gases can be “sniffed” out by the autonomous devices 110 by performing a sweep operation to identify a source of the carbon monoxide, the industrial chemicals, or the flammable gases (e.g., to detect gas leaks), according to some embodiments.

In some embodiments, the controller 106 and/or the base 104 are configured to use both position data obtained from the autonomous devices 110 and corresponding sensor data (e.g., temperature, humidity, IAQ, smoke detection, gas detection, etc.) to generate a map of variation of the sensor data throughout the building zone 102. In some embodiments, the controller 106 is configured to identify a location (e.g., position) of a maximum or a minimum of the sensor data (e.g., a location in building zone 102 where temperature is at a maximum, a location in building zone 102 where IAQ is lowest, etc.). Similarly, the controller 106 may generate a map of detected presence of particulate matter, specific DNA/RNA, etc., for various sensor data that is binary (e.g., indicating whether a presence is detected or not) and corresponding location for the detected presence.

In some embodiments, the autonomous devices 110 are configured to generate a positional mapping of the building zone 102 (e.g., while exploring the building zone 102 and determining different boundaries of the building zone 102). In some embodiments, dimensions (e.g. boundaries, size, floorplan, etc.) of the building zone 102 are known and stored in the controller 106. In some embodiments, the autonomous devices 110 perform local control to determine the path 108 along which the autonomous devices 110 travel through the building zone 102. In some embodiments, the path 108 is determined by the base 104 and/or the controller 106 (e.g., based on sensor data obtained from previous routes of the autonomous devices 110, based on real-time sensor data and position data obtained from the autonomous devices 110, etc.).

### Autonomous Devices

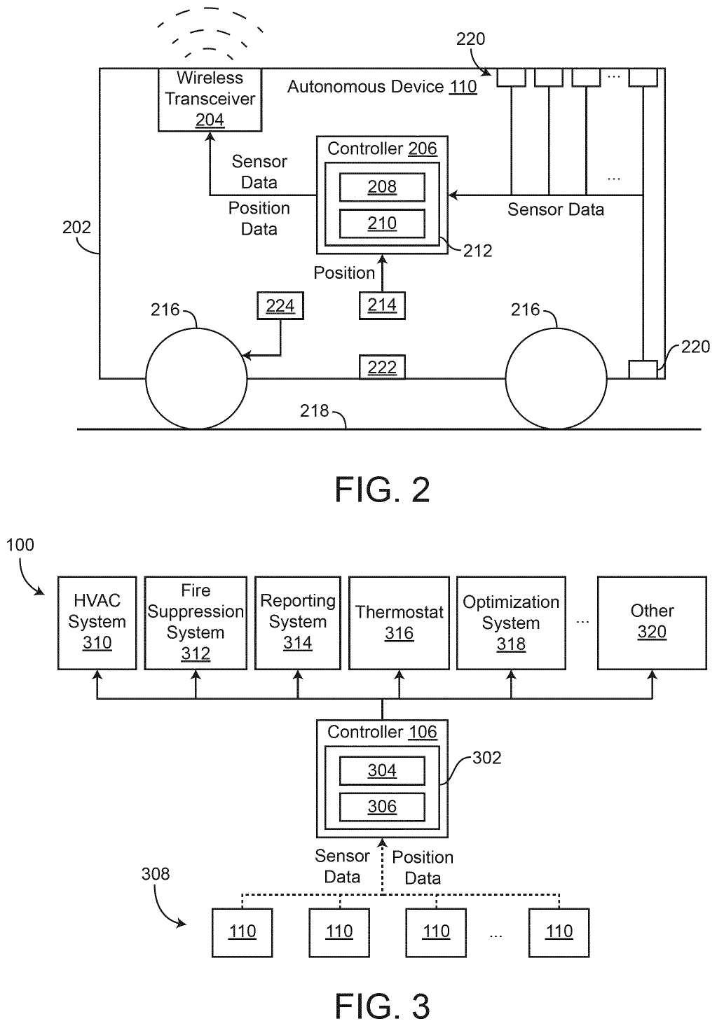

Referring now to FIG. 2, one of the autonomous devices 110 is shown, according to some embodiments. The autonomous device 110 includes a body, housing, or frame 202, a controller 206, a wireless transceiver 204, one or more sensors 220, an apparatus 222, a position sensor 214, and an electric motor 224, according to some embodiments. In some embodiments, the autonomous device 110 includes one or more tractive elements 216 that are configured to engage a ground surface 218 of the building zone 102 to drive, transport, rotate, etc., the autonomous device 110 about the building zone 102. In some embodiments, the tractive elements 216 are configured to receive a torque output from the electric motor 224 to drive the autonomous device 110 for transportation. In some embodiments in which the autonomous device is a ground-based vehicle, the tractive elements 216 may be or include wheels, tracks, or other elements for moving across the ground. In some embodiments in which the autonomous device 110 is a drone, the tractive elements 216 may be fans or impeller blades that are driven by the electric motor 224 or a set of electric motors.

The controller 206 is shown to include processing circuitry 212 including a processor 208 and memory 210, according to some embodiments. The processor 208 may be a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. The processor 208 may be a microprocessor, or, any conventional processor, controller, microcontroller, or state machine. Processor 208 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

Memory 210 (e.g., memory, memory unit, storage device) may include one or more devices (e.g., RAM, ROM, Flash memory, hard disk storage) for storing data and/or computer code for completing or facilitating the various processes, layers and modules described in the present disclosure. Memory 210 may be or include volatile memory or non-volatile memory, and may include database components, object code components, script components, or any other type of information structure for supporting the various activities and information structures described herein. According to an exemplary embodiment, the memory 210 is communicably connected to the processor 208 via processing circuitry 212 and includes computer code for executing (e.g., by the processing circuit or the processor) the one or more processes described herein.

In some embodiments, the apparatus 222 is configured to perform different functionality of operations of the autonomous device 110 as the autonomous device 110 travels about the building zone 102. For example, the apparatus 222 may be a host device apparatus, such as a vacuum cleaning apparatus including a fan or an impeller blade, a canister for collected matter, and an electric motor (e.g., similar to the electric motor 224), according to some embodiments. As another example, the autonomous device 110 may be a drone, and the apparatus 222 may be a camera or other device that is a part of the drone and performs functions of the drone such as navigation and capturing images/video.

In some embodiments, the autonomous device 110 include one or more arrays of the sensors 220. For example, the sensors 220 may include a temperature sensor, a mean radiant temperature sensor, a humidity sensor, a CO2 sensor, PM 2.5 sensor, a PM 10 sensor, a sensor configured to measure a presence or concentration of one or more VOCs, an ozone sensor, a sensor configured to measure a concentration of a particular ion, a light intensity sensor, a UV light sensor, a sensor configured to measure a presence or concentration of a particular DNA/RNA in an air sample, a carbon monoxide detector, a natural gas sensor, a flammable gas sensor, a smoke detector, an industrial chemical detector, an IAQ sensor, a dirt sensor, an irradiance sensor, an imaging device, etc. In some embodiments, the autonomous device 110 includes a tubular member that extends from a top of the autonomous device 110 and is configured to obtain an air sample at an elevated distance from the autonomous device 110 (e.g., at a height at which an occupant exhales). If the autonomous device 110 is a vacuum cleaning device or robot, the autonomous device 110 may operate a vacuum cleaning apparatus or a fan of the vacuum cleaning apparatus to stir up dirt on the ground surface 218 so that consistent readings are obtained by the sensors 220.

In this way, the autonomous device 110 can obtain sensor data related to comfort (e.g., temperature, humidity, etc.), IAQ (e.g., particulate matter, CO2, etc.), biological matter (e.g., DNA/RNA, specific virus DNA/RNA, etc.), and/or safety (e.g., carbon monoxide, flammable gases, smoke, industrial chemicals, etc.). Any of the sensor data obtained by the sensors 220 of the autonomous device 110 can be provided to the controller 206, according to some embodiments. In some embodiments, the controller 206 is configured to also obtain a corresponding position of the autonomous device 110 (e.g., from the position sensor 214). In some embodiments, the controller 206 may store the sensor readings and/or position data as timeseries data or other data correlating the sensor readings and/or position data with a time at which the sensor and/or position data was collected. In some embodiments, the controller 206 may store the sensor readings and position data in a form that correlates the sensor readings to positions of the autonomous device 110 at which the sensor readings occurred. The controller 206 provides the sensor data and the position data to the controller 106 and/or the base 104 by operating the wireless transceiver 204, according to some embodiments. In some embodiments, the controller 206 operates the wireless transceiver 204 to provide the sensor data and the position data to the controller 106 in real-time or near-real time. In some embodiments, the controller 206 collects the sensor data and the position as the autonomous device 110 travels along its route and stores the sensor data and the position data in the memory 210. The controller 206 may then provide the sensor data and the position data to the controller 106 when the autonomous device 110 returns to the base 104, according to some embodiments.

It should be understood that while the position of the autonomous device 110 is shown obtained from a position sensor (e.g., the position sensor 214), the position of the autonomous device 110 (e.g., relative position of the autonomous device 110 in the building zone 102, relative to the base 104, etc.) may be obtained using different systems or methods. For example, the position of the autonomous device 110 may be obtained using a triangulation technique, according to some embodiments.

### Control System

Referring now to FIG. 3, a portion of the system 100 is shown, according to some embodiments. Specifically, FIG. 3 shows a control system of the system 100, according to some embodiments. The control system includes the controller 106, one or more of the autonomous devices 110 (e.g., a fleet 308 of the autonomous devices 110), an HVAC system 310, a fire suppression system 312, a reporting system 314, a thermostat 316, an optimization system 318, etc., or another system or device 320, according to some embodiments. In some embodiments, the controller 106 is configured to receive sensor data and position data from the fleet 308 of the autonomous devices 110 (e.g., in real-time, near real-time, intermittently, etc.). The controller 106 may generate control signals and/or reporting data (e.g., the sensor data, the position data, a mapping of sensor data, an identification of a location where a virus-specific DNA/RNA is detected, etc.) to any of the HVAC system 310, the fire suppression system 312, the reporting system 314, the thermostat 316, the optimization system 318, or any other system or device 320. In some embodiments, the controller 106 is configured to adjust an operation of any of the HVAC system 310, the fire suppression system 312, the reporting system 314, the thermostat 316, the optimization system 318, and/or another system or device 320 using the sensor data and/or the position data obtained from any of or a combination of the autonomous devices 110.

In some embodiments, the fleet 308 includes autonomous devices 110 deployed in different spaces or different zones of spaces, such that the fleet 308 together covers different areas of a building. In some embodiments, the autonomous devices 110 of the fleet 308 may be configured to communicate data directly to one another (e.g., via peer-to-peer communication, such as wireless communication, e.g., via a mesh networking configuration) or indirectly via the controller 106. For example, in some embodiments, one autonomous device 110 may detect presence of a certain condition (presence of an air quality condition, such as a sensed air quality level below a threshold, presence of a contaminant or a virus, etc.) and communicate an indication of the detection to another autonomous device 110 and/or to the controller 106 for use in taking action with respect to other areas or zones (e.g., warning occupants of the presence of the air quality/contaminant issue, restricting access to the space, etc.).

The HVAC system 310 can be any system, device, collection of devices, building equipment, etc., that is configured to operate to affect an environmental or variable condition (e.g., temperature, humidity, etc.) of the building zone 102, according to some embodiments. The fire suppression system 312 may be an alert system (e.g., a fire alarm system, a fire panel, etc.) and/or a fire sprinkler system configured to extinguish a fire to either alert occupants of the building zone 102 regarding a presence of fire in the building zone 102, and/or to suppress the fire, according to some embodiments. The reporting system 314 may be a remote system that is configured to aggregate, analyze, and report data (e.g., providing graphical user interfaces, etc.) to a user, an occupant, a building administrator, another system, etc., according to some embodiments. The thermostat 316 may be a processing device (e.g., a wall mounted thermostat including a user interface or a touchscreen) that is configured to obtain environmental condition data of the building zone 102 and operate building equipment or the HVAC system 310 of the building zone 102, according to some embodiments. The optimization system 318 can be a system identification system that is configured to estimate, predict, or calculate one or more thermal properties of the building zone 102, a model predictive system, or any other optimization system configured to use data to determine one or more high-level control decisions to minimize energy consumption of a building, maximize efficiency of various systems or sub-systems of the building, etc., according to some embodiments. The other systems or devices 320 can include personal computing devices (e.g., technician smartphones), a fault diagnostics system, a remote database, a remote optimization or analytic system, etc., according to some embodiments.

The controller 106 is shown to include processing circuitry 302 including a processor 304 and memory 306, according to some embodiments. The processor 304 may be a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. The processor 304 may be a microprocessor, or, any conventional processor, controller, microcontroller, or state machine. Processor 208 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

Memory 306 (e.g., memory, memory unit, storage device) may include one or more devices (e.g., RAM, ROM, Flash memory, hard disk storage) for storing data and/or computer code for completing or facilitating the various processes, layers and modules described in the present disclosure. Memory 306 may be or include volatile memory or non-volatile memory, and may include database components, object code components, script components, or any other type of information structure for supporting the various activities and information structures described herein. According to an exemplary embodiment, the memory 306 is communicably connected to the processor 304 via processing circuitry 302 and includes computer code for executing (e.g., by the processing circuit or the processor) the one or more processes described herein.

The controller 106 can be configured to generate a mapping for any of the sensor data obtained from the autonomous devices 110 using the position data, according to some embodiments. For example, the controller 106 can generate a mapping of variation or presence of any of temperature, humidity, mean radiant temperature, carbon dioxide, PM 2.5 sensor data, PM 10 sensor data, VOC, ozone, ion concentration, light intensity, UV light intensity, carbon monoxide, flammable gas (e.g., natural gas), smoke or soot, industrial chemicals, specific DNA/RNA (e.g., virus-specific DNA/RNA), etc., with regards to position or location of the building zone 102. For example, the mapping can show positional or locational variation of the temperature, humidity, etc., throughout the building zone 102, according to some embodiments.

The controller 106 can use the mapping for any of the sensor data with respect to location of the building zone 102 to generate updates, activation signals, control signals, alert signals, display data, diagnostic data, system information (SI) data, etc., or other data related to sensed variables conditions of the building zone 102 for any of the HVAC system 310, the fire suppression system 312, the reporting system 314, the thermostat 316, the optimization system 318, and/or any other system or device 320 (e.g., a personal computing device, a technician system, a building automation system, a building administration system, a security system, etc.). For example, if the sensor data obtained from different positions or locations throughout the building zone 102 indicates poor IAQ, the controller 106 can operate the HVAC system 310 to increase ventilation to the building zone 102, according to some embodiments. Similarly, if the sensor data obtained from different locations or positions in the building zone 102 indicates that a fire is detected at a particular location in the building zone 102, the controller 106 can provide an alert to the fire suppression system 312, according to some embodiments.

### Clean Air Advantages and Implementations

Referring generally to FIGS. 1-3, the autonomous devices 110 can facilitate obtaining information regarding IAQ or particulate matter concentration throughout the building zone 102, according to some embodiments. The autonomous devices 110 can function as mobile or variable position IAQ sensors that are configured to obtain different IAQ sensor data (e.g., by drawing and sampling air samples) throughout the building zone 102, according to some embodiments. In some embodiments, the controller 106 is a thermostat that is configured to operate the HVAC system 310 and can use IAQ-related sensor data obtained from the autonomous devices 110 to operate the HVAC system 310 to achieve a desired IAQ (e.g., a desired particulate matter concentration in the building zone 102, a desired CO2 concentration in the building zone 102, etc.). Advantageously, using the autonomous devices 110 to obtain IAQ-related sensor data reduces costs that may be associated with installing and maintaining IAQ sensors throughout the building zone 102. The autonomous devices 110 can thereby facilitate improved clean air in the building zone 102 by obtaining IAQ sensor data from throughout the building zone 102, and providing the obtained IAQ sensor data from different positions or locations in the building zone 102 to a thermostat (e.g., the thermostat 316, the controller 106, etc.).

In some implementations, utilizing the autonomous devices 110 may allow for more granular/accurate detection of IAQ in the space/building. IAQ systems relying on a fixed network of sensors, even if multiple sensors are provided within the space/zone, can only sense the conditions of the air at or near the fixed locations. In contrast, the autonomous devices 110 can sense the conditions anywhere within the space that the autonomous devices 110 can move. As a result, the autonomous devices 110 can sample IAQ conditions throughout the space. In some implementations, the system may use a combination of fixed sensors and sensors on the autonomous devices 110 to sample conditions, such that the system can obtain more frequent readings, or even substantially continuous readings, of IAQ conditions in locations where the fixed sensors are located and periodic or less frequent readings of IAQ conditions using the autonomous devices 110.

### Periodic Data Collection

Referring still to FIGS. 1-3, in some embodiments, the autonomous devices 110 are dispatched at scheduled intervals to collect sensor data from throughout the building zone 102 (e.g., from different locations in the building zone 102). For example, the autonomous devices 110 may be dispatched to travel throughout the building zone 102 several times a day to obtain multiple daily mappings of sensor data or conditions with respect to location. Advantageously, obtaining such sensor data and/or mappings can facilitate improved real-time operation of any of the HVAC system 310, the fire suppression system 312, the reporting system 314, the thermostat 316, the optimization system 318, and/or any other system or device 320 of the building zone 102 (e.g., a lighting system).

### Modular Sensing Unit

Referring still to FIGS. 1-3, any of the sensors 220 or arrays of sensors can be electrically, communicably, or fixedly coupled with the autonomous device 110 (e.g., communicably connected with the controller 206 and fixedly coupled with the body 202) in a modular unit, according to some embodiments. In some embodiments, different modular units can be plugged into a corresponding port of the autonomous device 110 to fixedly couple the modular unit with the autonomous device 110 and communicably couple different sensors of the modular unit with the controller 206. For example, different modular units (e.g., a residential modular unit including specific sensors that are relevant for a residential application, a manufacturing-specific modular unit including specific sensors that are relevant for the manufacturing-specific application, etc.) can be removably coupled with the corresponding port of the autonomous devices 110, according to some embodiments. Advantageously, this facilitates ease of removal and installation of sensors depending on the application. Providing the sensors 220 in different modular units also allows the sensors 220 to be retrofit with the autonomous device 110, according to some embodiments. In some implementations, the controllers 206 of the autonomous devices 110 may be configured to sense the modular unit(s) connected to the autonomous devices 110 and enable/disable functions of the autonomous devices 110 in response, such as by enabling IAQ monitoring functions in response to an IAQ sensor being connected, infection response functions in response to an infection-related DNA/RNA sensor being connected, etc.

### Ambient and Target-Based Implementation

Referring still to FIGS. 1-3, the autonomous devices 110 can operate in a target-based manner to identify a location that a particular condition originates from, according to some embodiments. For example, if the autonomous devices 110 detect an unusual or excessively high or low sensor value (e.g., light intensity and/or UV light intensity indicating a presence of fire, low air quality reading, etc.), the autonomous devices 110 can be dispatched to identify an originating location in the building zone 102 resulting in the unusual, excessively high or low, or otherwise undesired sensor value, according to some embodiments. The autonomous devices 110 can perform a sweep of the building zone 102 to determine a location or a position in the building zone 102 from which the particular matter, the virus-specific DNA/RNA, etc., or any other undesired condition originates. For example, if one or more of the autonomous devices 110 detect a virus-specific DNA/RNA or a specific chemical presence, the autonomous devices 110 may perform a sweep (e.g. being dispatched from the base 104) to identify an originating location of the virus-specific DNA/RNA or the specific chemical presence within the building zone 102, according to some embodiments. Similarly, these features may be implemented to identify a location of a fire in the building zone 102, according to some embodiments. In some embodiments, the autonomous devices 110 are configured to provide their sensor data and position data to the controller 106 in real-time while performing the sweep of the building zone 102.

### Vacuum Apparatus Sensing

Referring still to FIGS. 1-3, the autonomous devices 110 can include a sensor configured to detect a presence or concentration of a virus-specific DNA/RNA (e.g., COVID-19), according to some embodiments. In some embodiments, the autonomous devices 110 include a fan that is configured to operate to draw an air sample across a filter. Different matter, quanta, or virus-specific DNA/RNA may be trapped on the filter, and can be sensed or detected, according to some embodiments. In some embodiments, the sensor that is configured to detect the virus-specific DNA/RNA uses existing infrastructure (e.g., a fan of a vacuum cleaning apparatus) of the autonomous devices 110. In this way, the apparatus 222 may have a dual-use, both for performing an operation and for performing sensing operations.

### Autonomous Alert Device

Referring still to FIGS. 1-3, the autonomous devices 110 can include one or more aural alert devices (e.g., speakers) and/or one or more visual alert devices (e.g., an array of light emitting diodes (LEDs)), according to some embodiments. In some embodiments, the autonomous devices 110 are configured to operate to provide a visual alert and/or an aural alert to occupants in the building zone 102 in response to the sensor data. For example, if the sensor data indicates that a virus-specific DNA/RNA is detected in the building zone 102 or that a fire or smoke is detected in the building zone 102, a visual and/or an aural alert can be provided to occupants of the building zone by activating or operating the one or more aural alert devices and/or the one or more visual alert devices.

### Building Management System/HVAC Control

Controller 106 may, in various embodiments, be a part of a building management system (BMS) or otherwise integrate with and/or communicate with a BMS that controls various systems of the building. The BMS may control HVAC, security, lighting, and/or other systems of the building using the data collected by the autonomous devices 110, in various implementations. For example, in some implementations, the controller 106 may be configured to transmit requests or control signals to the BMS and/or devices of the BMS to modify operation of the BMS based on a condition of the space sensed by the autonomous devices 110. In some implementations, in response to detecting an IAQ condition (e.g., IAQ level below a threshold air quality), the controller 106 may cause the BMS to control HVAC devices, such as air handling units (AHUs) and/or variable air volume (VAV) devices to increase a volume of outside air delivered to the space. In some implementations, the controller 106 may additionally or alternatively respond to such an IAQ condition by activating additional filtering to the air in and/or being delivered to the zone, such as by adding new filters and/or applying different filters to the incoming air at an AHU/VAV and/or activating one or more in-zone filtration devices. In some such implementations, the filtration devices may be activated based on the location of the autonomous devices 110 where the IAQ condition was sensed; for example, the system may include multiple in-zone filtration devices, and the in-zone filtration devices closest to the position of the autonomous devices 110 where the IAQ condition was sensed may be activated. Similar functionality could be provided in response to a sensed presence of a virus/pathogen/contagion.

Similarly, the controller 106 may additionally or alternatively control other systems of the BMS based on the sensed condition. In some implementations, the controller 106 may control security devices (door locks, entry gates, etc.) to restrict access to a space where an air quality or contamination issue is detected. In some implementations, the controller 106 may control fire system devices (e.g., sprinkler systems, alarms, etc.) based on detection of smoke or other indications of fire within the space. Various other systems may be controlled based on the sensed conditions and are contemplated within the scope of the present disclosure.

### Process

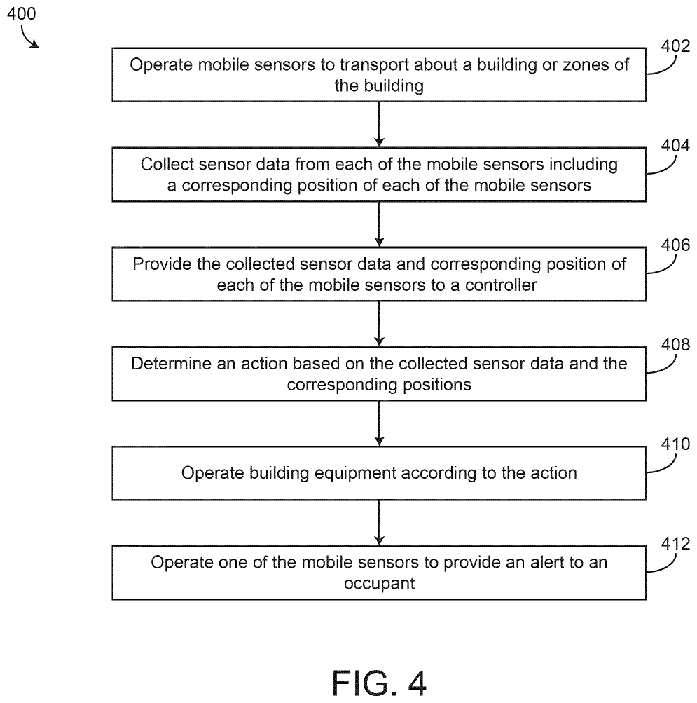

Referring to FIG. 4, a process 400 for operating a building control system is shown, according to some embodiments. The process 400 includes steps 402-412 and may be performed by the system 100, according to some embodiments. In some embodiments, the system 100 is performed using the autonomous devices 110 as sensors and/or alert devices.

Process 400 includes operating mobile sensors to transport about a building or zones of the building (step 402), according to some embodiments. In some embodiments, the mobile sensors are the autonomous devices 110. In some embodiments, the mobile sensors include sensors for measuring temperature, humidity, or a biological parameter in the building. The sensors can be positioned within modular units that are retrofit for the mobile sensors, according to some embodiments. In some embodiments, the mobile sensors are mobile vacuum cleaning robots or other autonomous devices. The mobile sensors can also include GPS or any other position sensor so that a current location or position of the mobile sensor within the building can be tracked, according to some embodiments. In some embodiments, the mobile sensors are operated to follow various paths or routes through the building. In some embodiments, the mobile sensors are controlled by a central controller that communicates with each of the mobile sensors. In some embodiments, the mobile sensors are configured to store a store a route and autonomously follow the pre-determined route. In some embodiments, the mobile sensors are configured to implement a local control scheme to “sniff-out” increased values and corresponding locations of one or more temperature, humidity, biological, or safety parameters. In some embodiments, step 402 is performed by the autonomous devices 110.

Process 400 includes collecting sensor data from each of the mobile sensors including a corresponding position of each of the mobile sensors (step 404), according to some embodiments. In some embodiments, the sensor data collected from each of the mobile sensors includes temperature, humidity or, a detection of a presence of a virus or biological quanta. In some embodiments, the sensor data is collected as the mobile sensors transport through the building. In some embodiments, the sensor data is collected once the mobile sensors reach certain locations. For example, the mobile sensors can be sent to a particular location in the building to obtain sensor data. In some embodiments, step 404 is performed by sensors 220 and 214 of the autonomous devices 110.

Process 400 includes providing the collected sensor data and corresponding position of each of the mobile sensors to a controller (step 406), according to some embodiments. In some embodiments, the sensor data is collected at the controller in real-time from the mobile sensors. In some embodiments, the sensor data is collected by the controller when the mobile sensors return to a hub, base, or home location or station. In some embodiments, the sensor data is collected as time-series data including a corresponding time-stamp and a corresponding position or location at which the sensor data was is collected in the building. In some embodiments, step 406 is performed by the wireless transceiver 204 of the autonomous device 110. For example, the mobile sensors may wirelessly transmit (e.g., via a network) the collected sensor data and corresponding position (and corresponding timestamp) to the controller 106, according to some embodiments.

Process 400 includes determining an action based on the collected sensor data and the corresponding positions (step 408) and operating building equipment according to the action (step 410), according to some embodiments. In some embodiments, step 408 includes determining an action for building equipment to affect a parameter that is measured by the mobile sensors. For example, the action may be performed to affect, adjust, or change a temperature, humidity, biological parameter, etc., within the building. In some embodiments, the action includes adjusting a heating, ventilation, or air conditioning system to affect the temperature, humidity, or biological parameter. In some embodiments, the action includes operating a filtration device (e.g., an in-zone filtration device) such as the filtration device disclosed in U.S. application Ser. No. 17/496,101, filed Oct. 7, 2021, the entire disclosure of which is incorporated by reference herein. In some embodiments, the action includes performing a Pareto optimization based on the sensor data obtained from the mobile sensors as described in U.S. application Ser. No. 17/483,078, filed Sep. 23, 2021, the entire disclosure of which is incorporated by reference herein.

Process 400 includes operating one or more of the mobile sensors to provide an alert to an occupant (step 412), according to some embodiments. In some embodiments, step 412 includes operating an alert light or a speaker of the mobile sensor to provide a visual or aural alert to the occupant. In some embodiments, the mobile sensors are operated to provide the alert to the occupant at a location where the condition that causes the alert was detected. For example, if the mobile sensor detects a presence of a particular virus at a current location of the building, the mobile sensor can notify occupants at the current location to move to a safe location, implement masking policies, disinfect, get tested, move to the exits, etc.

Advantageously, process 400 can be performed to provide detection of airborne viral matter, to detect a specific DNA or RNA sequence, etc., in a building at locations that are normally not accessible to a BMS. In some embodiments, the mobile sensors are cleaning devices (e.g., floor cleaners) that are retrofit with the wireless communications and sensing abilities as described herein. In some embodiments, the mobile sensors are configured to function as sniffers, where the mobile sensors autonomously seek out elevated particulate count, airborne viral matter or infectious quanta, etc.

### Security Features

Referring again to FIG. 2, the autonomous device 110 can include a camera as one of the sensors 220, according to some embodiments. In some embodiments, the camera is positioned at an outer periphery of the autonomous device 110 (e.g., at a front of the autonomous device 110) so that the camera can obtain image data surrounding or in front of the autonomous device 110. In some embodiments, the sensors 220 include multiple cameras that are configured to obtain image data in multiple directions of areas surrounding the autonomous device 110.

In some embodiments, the camera(s) are security cameras that are configured to obtain security footage for a security system. In some embodiments, the controller 206 is configured to obtain the image data or security footage from the cameras. The controller 206 may transmit the image data or security footage to the controller 106 via the wireless transceiver 204 in addition to the sensor data and/or the position data.

Referring to FIG. 3, the controller 106 may receive the security footage or image data from autonomous devices 110 and use the image data or provide the image data to a security system, according to some embodiments. In some embodiments, the controller 106 is configured to use the image data to detect a number of occupants in the building. The number of occupants at a particular location in the building can be determined based on the image data and may be used to determine an appropriate action for the HVAC system 310. In some embodiments, the controller 106 is configured to provide the image data to a security system for storage and later retrieval.

### Biological Parameter Detection

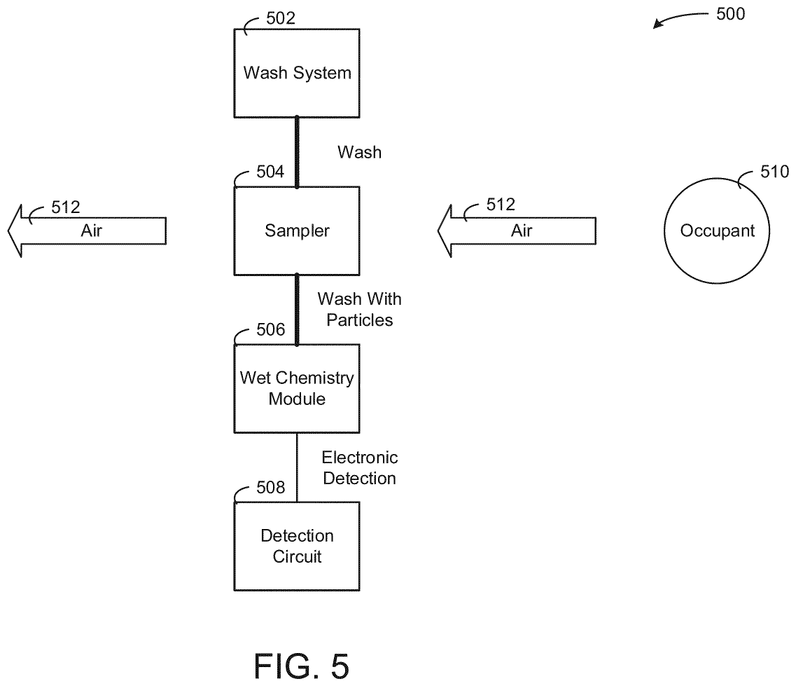

Referring now to FIG. 5, a biological sampling and testing system 500 is shown, according to some embodiments. The biological sampling and testing system 500 can be implemented at least partially locally on the autonomous devices 110 as one of the sensors 220. The biological sampling and testing system 500 can be a system configured to sense and identify biological agents. The sensing and testing can be performed based on genetic code of the biological agents (Deoxyribonucleic Acid (DNA) or Ribonucleic Acid (RNA)), testing for proteins of the biological agents, biological agent identifiers, etc. The biological sampling and testing system 500 can, in some embodiments, perform a quantitative polymerase chain reaction (qPCR) test to detect and identify a virus (e.g., COVID-19, Influenza, Ebola, respiratory syncytial virus (RSV), etc.). The biological agent that the system 500 detects can be a bacteria, etc., strep, legionella, etc. The biological sampling system 500 can identify mold or pollen. The biological sampling and testing system 500 can identify bioterrorism agents (e.g., anthrax, Ricin, etc.). The biological sampling and testing system 500 can include techniques of the various biological sampling and testing systems, such as those described in U.S. Patent Application Publication Nos. 2017/0081707, 2021/0222231, and 2018/0357365, the entireties of which are incorporated by reference herein. While various embodiments discuss biological sampling, it should be understood that the techniques described herein may also be applied to sensing and reacting to non-biological materials instead of or in addition to biological materials. All such modifications are contemplated within the scope of the present disclosure.

In the system 500, an occupant 510 (e.g., a person or animal) may exhale air 512. Furthermore, the occupant 510 could cough or sneeze. If the occupant 510 is infected with an infectious disease or is a carrier of an infectious disease, the exhaled air 512 can include particles of the infectious disease (e.g., if the particles are airborne). Various other biological agents can be exhaled, sneezed, and/or coughed out by the occupant 510. In various other cases, the biological agents could come from mold growing in a building, a water leak including a biological particle, an aerosol dispersed in the building, a powder or other agent released in the building, a contaminant or other substance present in the building or a zone of the building, etc.

The air 512 can be passed through a sampler 504. The sampler 504 can be configured to draw the air 512 across a filtration media, which traps particles from the air over a given sampling period. The filtration media can be removed from the sampler 504 and washed by a wash system 502. The wash system 502 can use a liquid (e.g., water, inert liquid, etc.) to wash the filtration media to remove the biological agents from the filtration media. The wash with particles can be delivered to a wet chemistry module 506 for chemical testing. The filtration media can, in some embodiments, be replaced in the sampler 504. The washed filtration media can, in some embodiments, be discarded after being washed.

The wet chemistry module 506 can take the fluid received in the wash, the fluid including particles of the biological agent, and perform chemical testing on the wash to detect and/or identify the biological agent. The wet chemistry module 506 can include one or more cartridges that perform the wet chemistry testing. The cartridges can be one-time or multiple time use cartridges that can be removed, discarded, and/or replaced.

The output of the wet chemistry module 506 can be electrical signals. The electrical signals can indicate a detection or an identify of a biological particle tested by the wet chemistry module 506. The detection circuit 508 can be configured to detect the electrical signals of the wet chemistry module 506. The detection circuit 508 can be configured to translate the electrical signals of the wet chemistry module 506 into concentrations of biological contaminants of interest.

While the present disclosure discusses examples where a wet chemistry process is used with the sensor, it should be understood that the present disclosure applies to any type of biological or other material sensing device, and is not limited to particular types of devices such as those that utilize wet sensing/testing.

In some embodiments, a Peltier system is used to collect liquid including biological particles, according to an exemplary embodiment. The Peltier system can include no moving parts and can perform heating and/or cooling via current of a power source. Similarly, light that shines on the elements of the Peltier system can cause current to flow to the power source. Because the Peltier system is a thermoelectric device it has no moving parts and is reliable and can be electrically controlled. The Peltier system is small enough that it can be located anywhere in a building and/or in the air systems described herein. In some embodiments, the power source is battery powered.

In some embodiments, a cooling effect created by the Peltier system and a fan can remove moisture from the air which captures biological agents in the moisture. In some embodiments, the Peltier system is operated to maintain a cool surface temperature slightly below an air dew point temperature. Condensation can be collected in a canister which is provided to the wet chemistry module for testing. Furthermore, the Peltier system can, in some embodiments, wipe the surfaces of the elements and clean between collections via a wiper system. In some cases, a technician may wipe the surfaces manually.

In some embodiments, a liquid collection system including the Peltier system 700 is shown, according to an exemplary embodiment. The system can include a fan configured to cause air to condensate on the elements. The condensate can be collected in the collection container which can be removable and the liquid removed from the collection container and provided to the wet chemistry module. In some embodiments, the collection container can feed liquid to the wet chemistry module and/or a detection circuit. The system can be installed in various systems, e.g., air systems and/or anywhere else in air ducts of a building.

In some embodiments, the liquid collection system is implemented on the autonomous devices 110. Multiple autonomous devices 110 can be installed permanently and/or temporarily in various spaces of a building to identify biological particles in the various spaces of the building. A technician can install the sensors and then remove the collection containers for testing with the wet chemistry module and/or the detection circuit. The autonomous devices 110 could be used to build a profile of potential mold, water leaks, diseases, etc. in various areas of a building. In some embodiments, the sampling and the testing can be separate. In some cases, the cost of a technician collecting samples from multiple sampling systems and delivering them to a centralized machine may be much lower than having multiple testing systems installed in the building.

In some embodiments, the mobile device could be used to screen individuals and/or perform searches. For example, when individuals go through security, the mobile device could be used to identify various biological agents. In some embodiments, the mobile device or another such system could be installed in an entrance area of a building and could control access to the building such that only individuals who test negative to a particular biological agent gain access to the building. The mobile device could be used in high security buildings, e.g., post offices, government buildings, etc.

The autonomous devices 110 can be collection devices that are configured to collect air samples and return to a testing location for testing of the air samples. In some embodiments, the autonomous devices 110 use the techniques described herein to obtain condensation (e.g., liquid samples) of air in the building. In some embodiments, the autonomous devices 110 are configured to implement the liquid collection system 800 as described in greater detail in U.S. Provisional Application No. 63/252,050, filed Oct. 4, 2021, the entire disclosure of which is incorporated by reference herein.

### Configuration of Exemplary Embodiments

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in any appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of any appended claims.

What is claimed is:

1. A building environmental control system comprising:
a mobile sensing unit comprising:
an air sampling system;
a sensor configured to measure an air parameter in an air sample at a current location of the mobile sensing unit; and
a building controller configured to:
obtain a measurement of the air parameter, and an indication of the current location from the mobile sensing unit; and
operate building equipment based on the measurement of the air parameter and the indication of the current location to affect an environmental condition of the building or to reduce an infection risk in the building.

2. The building environmental control system of claim 1, further comprising a fleet of the mobile sensing unit, wherein the fleet of mobile sensing units are configured to transport throughout the building and provide the building controller with a plurality of measurements of the air parameter at locations throughout the building, and to provide the building controller with corresponding indications of locations of the measurements of the air parameter.

3. The building environmental control system of claim 1, wherein the mobile sensing unit comprises a wireless transceiver configured to transmit the measurement of the air parameter at the current location, and the indication of the current location to the building controller.

4. The building environmental control system of claim 1, wherein the sensor is configured to detect a DNA or RNA sequence of a virus in the air sample at the current location of the mobile sensing unit.

5. The building environmental control system of claim 1, wherein the mobile sensing unit further comprises a security camera configured to obtain image data as the mobile sensing unit transports through the building, wherein the mobile sensing unit is configured to transmit the image data to the building controller.

6. The building environmental control system of claim 1, wherein the air parameter comprises at least one of an indoor air quality or an infectious quanta.

7. The building environmental control system of claim 1, wherein the air sampling system is a vacuum system for cleaning a floor of a building as the mobile sensing unit transports through the building, and the sensor is provided on a modular unit and is retrofit on the mobile sensing unit.

8. The building environmental control system of claim 1, wherein the mobile sensing unit comprises at least one of an aural alert device or a visual alert device configured to activate to provide an alert to an occupant at the current location in response to the sensor detecting a virus in the air at the current location.

9. A mobile sensor for a building, the mobile sensor comprising:
a sensor configured to measure an indoor air quality parameter in an air sample at a current location of the mobile sensor as the mobile sensor transports through the building; and
a wireless transceiver configured to transmit the measurement of the indoor air quality parameter and an indication of the current location of the mobile sensor to a building controller.

10. The mobile sensor of claim 9, wherein the mobile sensor is configured to transport along a predetermined route through the building.

11. The mobile sensor of claim 9, wherein the sensor is configured to detect a DNA or RNA sequence of a virus in the air sample at the current location of the mobile sensor.

12. The mobile sensor of claim 9, further comprising a security camera configured to obtain image data as the mobile sensor transports through the building, wherein the mobile sensor is configured to transmit the image data to the building controller.

13. The mobile sensor of claim 12, wherein the building controller is configured to use the image data to detect a number of occupants of the building at locations in the building.

14. The mobile sensor of claim 9, wherein the sensor and the wireless transceiver are provided on a modular unit and are retrofit on the mobile sensor.

15. The mobile sensor of claim 9, wherein the mobile sensor comprises at least one of an aural alert device or a visual alert device configured to activate to provide an alert to an occupant at the current location in response to the sensor detecting a measurement of the indoor air quality parameter that exceeds a threshold at the current location.

16. A method for controlling an indoor air quality in a building, the method comprising:
obtaining samples from air in the building at a plurality of different locations of the building using at least one autonomous cleaning device configured to transport through the building, perform a cleaning operation, and collect air samples;
measuring an air parameter in the building using the air samples; and
operating building equipment based on the air parameter to affect an indoor air quality in the building.

17. The method of claim 16, wherein the step of measuring the air parameter is performed locally on-board the autonomous cleaning device.

18. The method of claim 16, wherein the step of measuring the air parameter is performed off-board the autonomous cleaning device, wherein the autonomous cleaning device is configured to collect deliver the samples to a dock location in the building for measuring the air parameter.

19. The method of claim 16, further comprising operating an aural alert device or a visual alert device of the autonomous cleaning device to notify an occupant regarding the air parameter in the building.

20. The method of claim 16, wherein the air parameter comprises at least one of an infectious particle in the air, or an indoor air quality.
